(19) United States
(12) Patent Application Publication
(10) Pub. No.: US 2004/0158480 A1
(43) Pub. Date: Aug. 12, 2004

(54) System and method for bundling resources

(76) Inventors: Mitchell D. Lubars, Austin, TX (US); Jonathan T. Stokes, Austin, TX (US); Lance Eason, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/679,192

(22) Filed: Oct. 3, 2003

Related U.S. Application Data
(60) Provisional application No. 60/415,886, filed on Oct. 3, 2002.

(51) Int. Cl. G06F 17/60

(52) U.S. Cl. 705/1

(57) ABSTRACT

One embodiment of the present invention includes a system of bundling products comprising a set of computer instructions stored on a computer readable medium and executable by a computer processor, the set of computer instructions comprising instructions executable to, receive a set of resources; compare the set of resources to one or more applicable bundle patterns; and generate one or more bundled packages based on the comparison. In one embodiment of the present invention, the set of resources can be a raw package that represents the cross product of solutions designed to meet a user's defined needs. Another embodiment of the present invention can include receiving a set of resources, comparing the set of resources to one or more applicable bundle patterns, and generating one or more bundled packages based on the comparison.

### RELATED APPLICATIONS

This application claims priority under 35 U.S.C. 119(e) to U.S. Provisional Patent Application No. 60/415,886, entitled “System and Method for Packaging and/or Bundling Products and Services” by Jonathan T. Stokes, filed Oct. 3, 2002, which is hereby fully incorporated by reference herein.

### TECHNICAL FIELD

Embodiments of the present invention relate generally to systems and methods for bundling resources. More specifically, embodiments of the present invention provide methods and systems for generating bundled packages of resources based on defined bundle patterns.

### BACKGROUND

Bundling is the selling of two or more products and/or services jointly, rather than separately. Bundling has become ubiquitous in the fast food industry where so-called “combo” meals are offered for a price that is usually lower than the price of the separately purchased food items. The combo meals usually contain a main entree, such as a hamburger, a side, such as French fries and a drink. The consumer generally feels that he or she is getting a bargain by purchasing the three items as a combo rather than purchasing the items separately or purchasing a smaller number of items.

Bundling has become popular in many other industries. In the electronics industry, for example, stereo tuners are bundled with speakers, computers with peripherals, gaming consoles with games and so on. Similarly, software products are often bundled together (e.g., web browsers are bundled with operating systems, games are bundled together into sports or action bundles, etc.). In the above examples, products are bundled together to form product bundles. However, products and services can also be bundled. In the mobile telephone market, telephones are often bundled together with mobile telephone service. Finally, as an example of pure service bundling, a telephone company will often bundle call-waiting, voice mail, and caller identification services as a package.

Current bundling systems, however, are typically insufficient for complex provisioning, such as product provisioning in the telecommunications industry. Current bundling systems typically rely on a limited number of predefined bundles, but are not responsive across customer's actual needs. For example, if a customer needs a data network and direct internet access, typical prior art systems will contain predefined bundles of products for providing a data network and predefined bundles of products for providing direct internet access. The bundles can be sold to a customer on behalf of the vendor that defined the bundle. These systems, however, do not typically automatically generate bundles. Moreover, because the bundles are predefined, the bundles are not generated dynamically based on user input. Other prior art systems apply bundling to a small set of selected items to generate one or more bundles. These systems, however, are deficient because they do not typically bundle across different sets of user needs.

### SUMMARY OF THE INVENTION

Embodiments of the present invention provide systems and methods for product bundling that substantially eliminate or reduce disadvantages and problems associated with previously developed bundling systems and methods.

One embodiment of the present invention includes a system of bundling products comprising a set of computer instructions stored on a computer readable medium and executable by a computer processor, the set of computer instructions comprising instructions executable to, receive a set of resources (e.g., products, options, and/or services); compare the set of resources to one or more applicable bundle patterns; and generate one or more bundled packages based on the comparison. In one embodiment of the present invention, the set of resources can be a raw package that represents a combined solution from a cross product of multiple solutions designed to meet a user's defined needs.

Another embodiment of the present invention can include receiving a set of resources, comparing the set of resources to one or more applicable bundle patterns, and generating one or more bundled packages based on the comparison.

Yet another embodiment of the present invention can include a system of bundling products comprising a set of computer instructions stored on a computer readable medium and executable by a computer processor, the set of computer instructions comprising instructions executable to maintain a set of patterns and a set of resources. Each resource can be associated with one or more patterns from the set of patterns. The computer instructions can be executed to generate a raw package containing at least one resource from the set of resources. Based on the associations between resources and patterns, the computer instructions can be further executable to determine a set of potentially applicable, filter the set of potentially applicable patterns based on rules and anchors associated with each potentially applicable pattern to determine a set of applicable patterns. The set of applicable patterns can include a set of applicable bundle patterns. The computer instructions can be executable to compare the set of applicable bundle patterns to the raw package to generate a set of bundled packages.

Embodiments of the present invention provide advantages over previous bundling systems by bundling across solutions to address multiple sets of user needs.

Embodiments of the present invention provide another advantage by using bundle patterns to define bundles. The use of bundle patterns can provide dynamic and flexible bundling.

Embodiments of the present invention provide another advantage by allowing bundling to be contained by rules, thereby preventing invalid bundles from being formed.

Embodiments of the present invention provide yet another advantage by providing a rating system that accounts for a user's satisfaction with a particular overall solution.

### BRIEF DESCRIPTION OF THE FIGURES

For a more complete understanding of the present invention and the advantages thereof, reference is now made to the following description taken in conjunction with the accompanying drawings in which like reference numerals indicate like features and wherein:

FIG. 1 illustrates one embodiment of a system for bundling;

FIG. 2 is a diagrammatic representation of a software system according to one embodiment of the present invention;

FIG. 3A is a diagrammatic representation of a generic tree structure for one embodiment of a bundle pattern and examples of data and/or processes that can be associated with the bundle pattern according to one embodiment of the present invention;

FIG. 3B illustrates several example bundle patterns according to one embodiment of the present invention;

FIG. 4 is flow chart illustrating one embodiment of a method for determining which bundle patterns apply to a raw package;

FIG. 5 is a flow chart illustrating one embodiment of a method for defining conflict set partitions;

FIG. 6 is a diagrammatic representation of generating bundled packages requiring exact matching according to one embodiment of the present invention;

FIG. 7 is a diagrammatic representation of generating bundled packages using partial matching according to one embodiment of the present invention;

FIG. 8 is a flow chart for generating bundled packages according to one embodiment of the present invention;

FIG. 9 is a diagrammatic representation of a system that employs transforms according to one embodiment of the present invention;

FIG. 10 is a diagrammatic representation of an example transform according to one embodiment of the present invention;

FIG. 11 is a diagrammatic representation of post-bundling processing according to one embodiment of the present invention;

FIG. 12 is a diagrammatic representation of bundling in the telecommunications industry, according to one embodiment of the present invention;

FIG. 13 illustrates one embodiment of post bundling processing, according to one embodiment of the present invention; and

FIG. 14 illustrates one embodiment of the present invention in which validation and pricing can occur separately from bundling, according to one embodiment of the present invention.

### DETAILED DESCRIPTION

Embodiments of the present invention provide a system and method for bundling products and/or services. In one embodiment of the present invention, a set of available resources (e.g., products, options or services) can be compared to a set of bundle patterns to determine if the resources can be bundled. If a set of resources matches a bundle pattern a bundled package can be formed. Each set of resources can match (fully or partially) one or more bundle patterns to form bundled packages. In one embodiment of the present invention the bundled packages can be rated based on, for example, price and the degree to which the resources satisfy the customer needs to determine the most preferred bundle packages.

The set of resources against which a bundle pattern is compared, in one embodiment of the present invention, can be a raw package that is a member of the cross product of various solutions that meet a user's defined needs. For example, if a user defines that he or she needs a data network and direct internet access, the resources that meet the needs for a data network and the resources that meet the needs for the direct internet access can be different, but may also partially or fully overlap. The raw package can contain the resources to meet each of these needs. The raw package may not be optimal, however, because it contains redundant resources or is not attractively priced. Therefore, the raw package can be further bundled to offer more attractive pricing, eliminate redundancies in products or services or to provide other improvements.

In one embodiment of the present invention, the raw package can be compared to one or more defined bundle patterns to generate packages that contain bundled resources. The bundle patterns can be applied to resources across solutions to bundle resources from one or more solutions in the same raw package. For example, the bundle pattern can be used to bundle resources from both the data network solution and direct internet access solution.

According to one embodiment of the present invention, partial matching between a raw package and bundle patterns is permitted. With partial matching, a bundled package can be generated that includes resources not in the raw package if the raw package contains at least some of the resources specified by the bundle pattern.

In addition to bundle patterns, transforms can be applied to the raw package or bundled packages that specify that a resource or bundle in the raw package or bundled package should be changed. It should be noted that, in one embodiment of the present invention, a bundle pattern is a special case of a transform in which multiple resources are replaced by a single bundle. Additional patterns can also be applied to drive promotions and incentives. Although these patterns may specify the addition of resources to a raw or bundled package, they generally do not change the resources already contained in the raw or bundled package. For purposes of this application, the patterns that do not specify changes to resources (or bundles) already in the packages to which they apply will be termed “nontransform packages.”

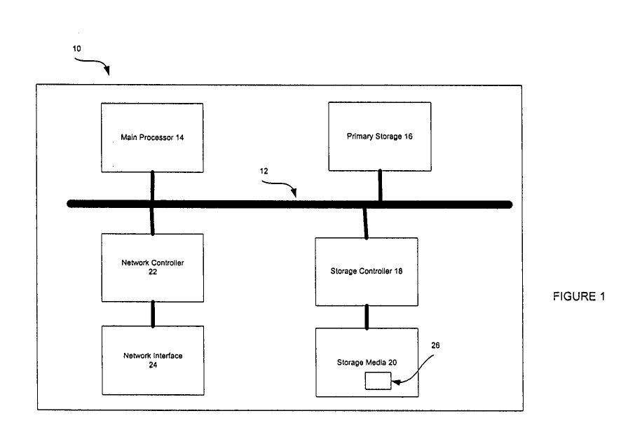

FIG. 1 illustrates one embodiment of a system 10 for bundling. For the purposes of example, system 10 comprises a main bus 12, a main processor 14, a primary storage medium 16, a secondary storage controller 18, a storage media 20, and optionally a network controller 22, a network interface 24. Other devices which may be connected to or part of such a computer such as display, mouse, keyboard, and so forth. The main processor 14 communicates with the other components by way of the main bus 12. This main processor 14 can be a general purpose processor, a limited processor such as an ASIC or microcontroller, or any other instruction execution machine. The primary storage 16 can provide transient memory or storage space for use by programs executing on the main processor 14. The main processor 14 communicates with the primary storage in any manner known in the art.

The secondary storage controller 18 connects a storage media 20 such as a hard drive, CD-ROM, floppy, tape drive, optical storage medium, memory or other storage device to the main processor 14 by way of the main bus 12. The main processor 14 communicates with the secondary storage controller 18 by way of the main bus 12, and the secondary storage controller 18 is used to read and/or write the storage media 20 on behalf of the main processor 14.

System 10 may communicate with other computers by way of a network. This is accomplished by attaching a network interface 24 to the network and attaching the network interface 24 to a network controller 22, and connecting the network controller 22 to the main bus 12. Computer instructions running on the main processor may then access other computers across the network in any of the conventional ways, e.g. by executing “protocols” which affect the transmission and reception of protocol data units, packages, etc. over the data transmission network.

In one embodiment of the present invention, storage media 20 can store a set of computer instructions 26 that are executable by processor 14. During execution, portions of computer instructions 26 and data can be stored in primary storage 16, as would be understood by those of ordinary skill in the art. Processor 14 can execute computer instructions 26 to receive a set of raw packages based on a set of solutions, compare the raw packages to a set of bundle patterns, and generate a set of bundled packages based on the comparison. While shown as a single computer in FIG. 1, it should be understood that computer instructions 26 can be distributed among several computing devices.

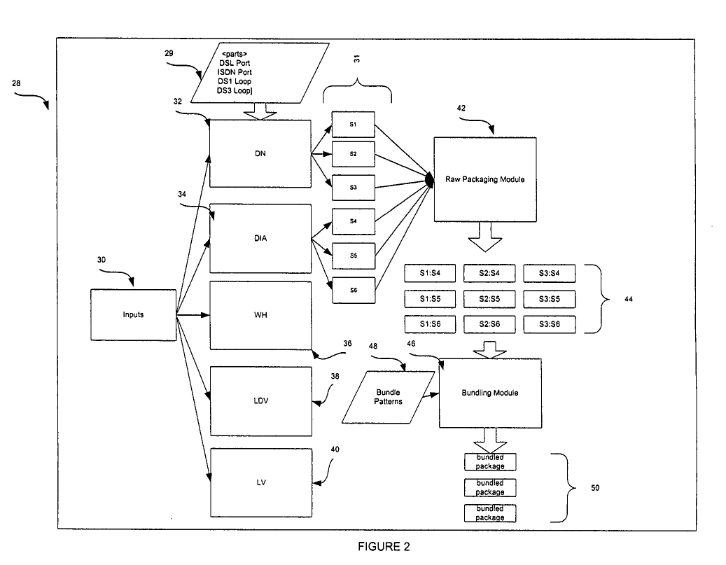

FIG. 2 is a diagrammatic representation of a software system 28 according to one embodiment of the present invention. For the sake of example bundling will be primarily discussed in the context of the telecommunications industry. However, it should be understood that the present invention is equally applicable to bundling in a variety of fields.

In system 28 a set of resources 29 are available for use in meeting a user's needs. In the simple example of a fast food restaurant, the resources represent the food items available. For the telecommunications industry, the resources can represent the products (e.g., DSL Ports, ISDN Ports, DS1 Loops, DS3 Loops, Firewalls, 128K connections, rate plans, and other products known in the art) drawn from various services (e.g., data network, direct internet access, long distance voice, local voice and other telecommunications services known in the art). In one embodiment, the resources can be organized as one or more collections. In the example of FIG. 2, the collection (e.g., the <parts> collection) contains products drawn from one or more services. It should be noted that the foregoing is provided by way of example only and resources 29 can be stored in any manner known in the art.

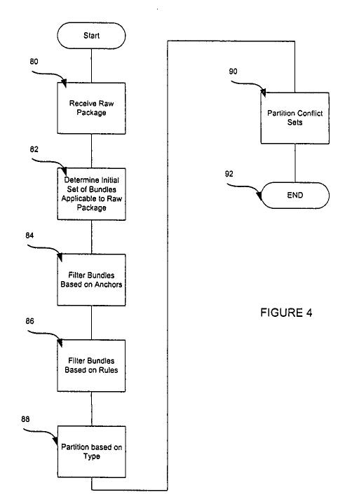

The individual resources can be associated with a variety of data including, for example price, contract terms, suppliers, warranty information or any other arbitrarily defined information. Additionally, as will be discussed in conjunction with FIG. 4, each resource can be associated with one or more patterns. The associated patterns can include bundle patterns used to determine if a particular resource can be bundled with other resources given a particular user's needs.

A user can input a set of user needs (represented by inputs 30). This can be done, for example through a graphical user interface. A set of solution engines generate solutions 31 for a particular aspect of a user's needs based on a set of resources 29 available to each solutions engine. Each solution contains a resource (e.g., a product) or set of resources that fulfill the user's need for that category of solution. Thus, each solution is a particularly configured set of one or more resources.

As an example, FIG. 2 illustrates several solutions engines for the telecommunications industry including a data network (DN) engine 32, a direct internet access (DIA) engine 34, a web hosting (WH) engine 36, a long distance voice (LDV) engine 38 and a local voice (LV) engine 40. If a user desires an overall solution with data network and direct internet access, DN engine 32 and DIA engine 34 can generate a set of DN solutions (represented by solutions S₁, S₂, S₃) and DIA solutions (represented by solutions S₄, S₅ and S₆), respectively. A DN solution (e.g., solution S₁) might include the resources of an ATM port and an ATM loop, while a DIA solution (e.g., S₄) might include the resources of a DSL Port and a DSL loop.

Embodiments of engines for generating solutions are described in U.S. patent application Ser. No. 09/909,240, entitled “Expert System Adapted Dedicated Internet Access Guidance Engine,” filed Jul. 19, 2001, to Rod Mancisidor et al., U.S. patent application Ser. No. 09/909,241, entitled “Expert System Adapted Dedicated Internet Access Guidance Engine,” filed Jul. 19, 2001, to Rod Mancisidor et al. and U.S. patent application Ser. No. 09/909,250, entitled “Expert System Supported Interactive Product Selection and Recommendation,” filed Jul. 19, 2001, to Rod Mancisidor et al. (collectively, the “Expert System Applications”), each of which is fully incorporated by reference herein. It should be noted that the use of software engines to generate solutions is provided by way of example only, and, in other embodiments of the present invention, solutions can be provided in any other manner known in the art, such as by being predefined (e.g., hamburgers and chicken sandwiches can be predefined solutions for the need for an entree), or by being entered directly by the user.

The solutions for each set of user needs (e.g., the solutions produced by each solution engine) can be packaged by a packaging module, such as packaging module 42, into raw packages 44. The raw packages 44 represent, in one embodiment of the present invention, the cross product of the solutions that provide the resources to meet the user's defined needs. For example, for a customer requiring DIA and DN services, the solutions S₁, S₂, and S₃ can be combined with solutions S₄, S₅ and S₆ to form raw packages 44 that satisfy the DN and DIA needs of the customer. Table 1 is an example list of the raw packages that can be generated.

TABLE 1

| DN | DIA | Raw Package |
|---|---|---|
| S₁ | S₄ | S₁:S₄ |
| S₁ | S₅ | S₁:S₅ |
| S₁ | S₆ | S₁:S₆ |
| S₂ | S₄ | S₂:S₄ |
| S₂ | S₅ | S₂:S₅ |
| S₂ | S₆ | S₂:S₆ |
| S₃ | S₄ | S₃:S₄ |
| S₃ | S₅ | S₃:S₅ |
| S₃ | S₆ | S₃:S₆ |

Raw packages 44, in the example of Table 1, are the cross product of the solutions for each service that is to be fulfilled. Raw packages 44 contain the set of solutions grouped together, without bundling of resources, and are packages that can provide an overall solution to fulfill a user's needs, but may not be optimal for the user.

In the above example, three solutions were generated for each service, leading to nine raw packages. However, the number of solutions generated for each service can be arbitrarily complex, leading to a large number of raw packages. If, for example, a user indicated that in addition to DIA services and DN services, he or she needed LV services, LV engine 40 can generate additional solutions. If the number of solutions generated by LV engine 40, is, for example, twenty five, the number of raw packages will increase to 225. As the number of solutions generated for each service grows the number of raw packages can become large. If each raw package is then further processed, processing could potentially take a significant amount of time. Therefore, in one embodiment of the present invention, raw packaging module 42 can rate the raw packages to eliminate some raw packages from further processing.

Raw package ratings can be based on ratings assigned to the solutions, by for example, the solutions engines. Table 2 provides example ratings for each solution S₁ through S₆ for the example in which a user indicated a set of DN and DIA needs.

TABLE 2

| Solution | Rating |
|---|---|
| S₁ | .9 |
| S₂ | .8 |
| S₃ | .7 |
| S₄ | .95 |
| S₅ | .85 |
| S₆ | .75 |

To generate the cross product of ranked raw packages, in one embodiment of the present invention, raw package module 42 can select the solution from each service (e.g., DN or DIA) with the highest rating. In this example S₁ and S₄ have the highest solutions ratings, so S₁:S₄ can be selected as the highest rated raw package. As will be demonstrated in following examples, the next highest rated solutions can then be selected to replace the previously selected solutions of the same solution type in each raw package in which the replaced solution has already been selected. To further explain, S₅ has a 0.85 rating, so S₅ can replace S₄ and the next highest rated package will be S₁:S₅. After S₅, S₂ is the next highest rated solution, S₂ will replace S₁ for the generated raw packages that contained S₁, yielding S₂:S₄ and S₂:S₅. As a final example, S₆ has the next highest rating of 0.75 and can replace S₅ in raw packages that contain S₅ to generate S₁:S₆ and S₂:S₆ Table 3 lists the relative rankings of the raw packages from Table 1 following this process.

TABLE 3

| Ranking | Raw Package |
|---|---|
| 1 | S₁:S₄ |
| 2 | S₁:S₅ |
| 3 | S₂:S₄ |
| 4 | S₂:S₅ |
| 5 | S₁:S₆ |
| 6 | S₂:S₆ |
| 7 | S₃:S₄ |
| 8 | S₃:S₅ |
| 9 | S₃:S₆ |

The rankings of Table 3 are provided by way of example and, as would be understood by one of ordinary skill in the art, any rating system or no rating system, can be employed. Once the raw packages are rated, the raw packages can be culled by removing raw packages that fall below a particular aggregate rating of solution ratings, mean solution rating or other arbitrarily defined limit (e.g., percentile ranking). For example, if raw packages having a mean solution rating of 0.775 or below are eliminated, then raw packages S₃:S₅, S₃:S₆ and S₂:S₆ will not be further processed because they have mean solution ratings of 0.775, 0.725 and 0.775, respectively. Alternatively, if the bottom 33% of raw packages are eliminated, then S₃:S₄, S₃:S₅, and S₃:S₆ will not be further processed.

The raw packages 44 selected for further processing can be passed to a bundling module 46 to generate bundled packages 50. Bundling module 46 can compare the raw packages 44 (or selected subset) to a set of bundle patterns 48 to determine which resources in a given raw package can be bundled. A bundle pattern is essentially a data structure template that can be compared to a raw package to determine if the raw package fits the bundle pattern's resources and/or resource classes and satisfies its cardinalities, rules and/or other constraints.

If a raw package fits the bundle pattern a bundled package can be generated from the raw package. As an example, a bundle pattern can specify that if a port and firewall are found in the same raw package, the port and firewall can be bundled together into a lower priced bundle. Thus for example, if raw package S₁:S₄ includes the following resources: an ATM Loop, an ATM port, a firewall and a DS1 loop, the bundling module can generate a bundled package including an ATM Loop, a DS1 loop and a bundled ATM port/firewall. It should be noted that each raw package can be the basis for multiple bundled packages. For example, if raw package S₁:S₄ fits more than one bundle pattern, distinct bundled packages can be created for each matched bundle pattern. Bundled packages 50 and raw packages 44 can be passed to additional modules that rate the bundled packages and recommend a set of the best bundled packages and raw packages.

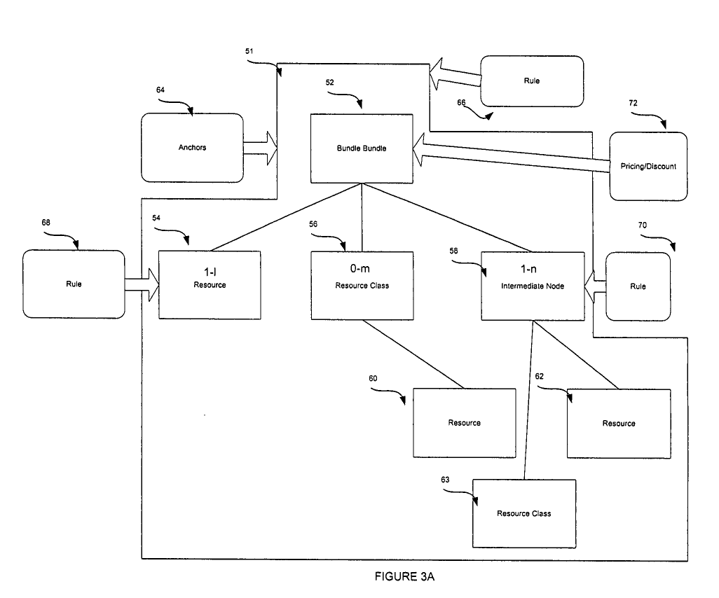

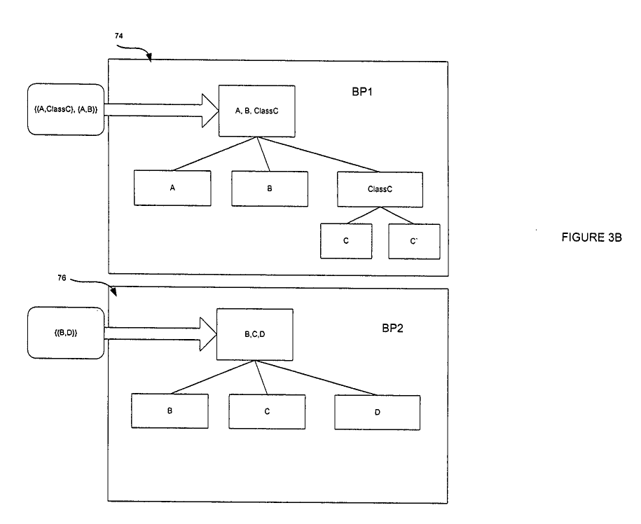

FIG. 3A is a diagrammatic representation of a generic tree structure for one embodiment of a bundle pattern 51 that can be applied to raw packages to generate bundled packages. Each bundle pattern can specify a bundle description 52 and can include components and cardinalities for the bundle. The components can be resources, for example, resource 54, resource 60 and resource 62, and resource classes, for example, resource class 56. The resource class defines a set of resources that can match the corresponding component of bundle pattern 51. The tree structure for bundle pattern 51 also includes intermediate node 58. As will be discussed below, intermediate node 58 can allow rules and other information (such as pricing/discount data) to be passed to or be associated with resources or resource classes under it, such as resource 62 and resource class 63.

Additionally, bundle pattern 51 can include cardinalities. For example, the 1-1 associated with resource 54 indicates that exactly one of resource 54 is required for bundle pattern 51 to apply. However, the (1-n) associated with resource 58 indicates that there must be at least one resource 58 for bundle pattern 51 to apply and that there may be more than one instance of resource 58 bundled, whereas the (0-m) associated with resource class 56 indicates that a member of resource class 56 is optional, but that many instances of that class may be included in the bundle. It should be noted the cardinalities and components illustrated in FIG. 3A are provided by way of example and, as would be understood by those of ordinary skill in the art, bundle pattern 51 can be arbitrarily complex and can contain an arbitrary number of nested, intermediate nodes.

Bundle pattern 51 can be compared to a raw package to determine if the raw package meets the component, cardinality and rule limitations of bundle pattern 51. In another embodiment of the present invention, partial matches can be generated, in which only a portion of the components of bundle 51 must be matched for bundle 52 to be generated. If a raw package meets the requirements of bundle pattern 51 for a match or partial match, a bundled package containing an instance of bundle 52 can be generated, which may even introduce products that were not present in the raw package. For example, if the raw package includes a burger and fries, a bundle pattern for burger, fries and a drink can partially match the raw package, leading to a bundle package that contains the burger, fries and a drink for a special bundle price.

In one embodiment of the present invention, every defined bundle pattern can be compared to the raw packages. However, for a system with a large number of bundle patterns or resources, this can lead to time intensive processing. To reduce processing requirements, bundle pattern 51 can be associated with anchors 64. Anchors 64 represent the components that especially characterize bundle 52. For example, if A, B, C and D are resources, bundle pattern 51 can be associated with anchors A and B or A and D (denoted {{A,B},{A,D}}. This means that if A and B or A and D are present in the raw package, bundle pattern 51 will apply. Otherwise bundle pattern 51 will not be considered.

In addition to anchors, rules can be associated with bundle pattern 51 as a whole, such as rule 66, or with components of bundle pattern 51, such as rule 68 and rule 70. Rules can determine if bundle pattern 51 is applicable based on the context of a particular application. The context can include user information, site location, contract term, date, which services a user requested or any other arbitrary data that can be specified in rules. As an example, rule 66 can specify that bundle pattern 51 is only applicable if the user requested local voice service, or that bundle pattern 51 is only applicable if the user lives in a specific zip/postal code. Rule 68 can specify that even if resource 54 is present, the resource can only match in particular circumstances (e.g., between particular dates) or so long as the raw package contains another resource that is not bundled in bundle 52. Rule 70 can function similarly, but can be applied to all resources and/or resource classes under intermediate node 58. Additionally, it should be understood that arbitrarily complex rules can be programmed that can determine the applicability of a particular bundle pattern.

In one embodiment of the present invention, the rules can be implemented as Java logical expressions, with special extensions for expression quantification and aggregation. The following are examples of quantifiers and aggregations that can be used within the rules, according to one embodiment of the present invention:

Universal Quantification:

Forall(<Type><object>in<Collection> [where (<logical expressionl>)])(<logical expression2>)

Existential Qualification:

Exists(<Type><object>in<Collection> [where (<logical expressionl>)])(<logical expression2>)

Generalized Aggregation:

<Type2>Aggregate(<Type1><object> in <Collection> [where (<logical expressionl>)],<function name>) (<expression>)

Using the example from FIG. 2 in which particular resources (e.g., parts) are associated with a parts collection, an example of the Universal Quantifier expression can be:

Forall(Part in Parts)

(part.contractTerm==24)∥(part.contractTerm==36))

In this case the context or data to which the rule is applied includes the contract term for the products in the raw package. According to this rule, the bundle pattern with which it is associated will only be applied if the contract term for all resources in the raw package is either 24 or 36 months.

An example of the Existential Quantification can be:

Exists (Bundle part in immediateparts where part.technology==“Frame Relay”))(part.provider.name==“Fred's Parts”)

In this case, the bundle pattern with which this rule is associated will only apply if there is at least one resource for the bundle pattern that uses Frame Relay technology and is supplied by a provider named Fred's Parts.

As a final example, an aggregation expression can be as follows:

(Integer Aggregate (Bundle part in parts where (is a(part,“Port”)),sum)(part.channels))>24

In this example, the bundle pattern with which the rule is associated will only apply if the raw package contains one or more “Ports” and the aggregate number of channels of all those ports meets a specified minimum.

It should be noted that the syntax for rules provided above was provided by way of example only and any suitable syntax for expressing rules can be used. As would be understood by one of ordinary skill in the art, any programming language and/or structure can be used to define arbitrarily complex rules that govern the applicability of bundle patterns. The rules can be associated with the bundle pattern as a whole or with particular components of the bundle pattern.

In addition to anchors and rules, bundle 52 can be associated with pricing and/or discount information 72. Pricing/discount information 72 can specify that if an instance of bundle 52 is generated, the bundle will have a particular price. In addition, pricing/discount information 72 can specify that each of the constituent resources of the instance of bundle 52 will be discounted by a particular amount or percentage. Additionally, pricing/discount information can be provided for intermediate node 58, resource 54, resource 56, resource 62, resource class 56 and resource class 63 components 54, 56, 60 and 62. In another embodiment of the present invention resource 54, resource 56, resource 62, resource class 56 and resource class 63 will only be associated with pricing, but not discount data.

To summarize, a bundle pattern can be logical template that can be compared to a raw package to determine if resources in the raw package can be bundled. In one embodiment of the present invention, the bundle pattern can have associated anchors that define required resources for the bundle pattern to apply. The bundle pattern or its components can also have associated rules that can be executed to determine the applicability of the bundle pattern based on contextual information such as user information, warranty information, contract terms or other information. Additionally, the bundle pattern and its components can have associated pricing and/or discount information that can be used to determine the price for a bundle.

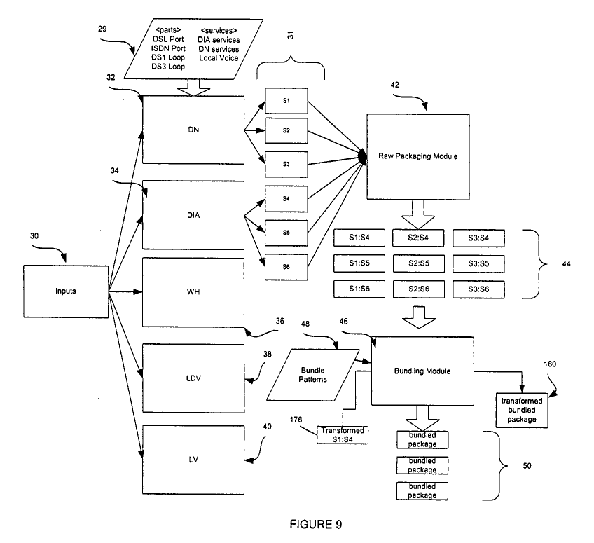

In the above example bundle pattern 51 defined a bundle of resources. Additional patterns, such as transforms, as described in conjunction with FIG. 9, can specify which resources in a raw package or bundled package can be replaced with other resources. It should be noted that, in one embodiment of the present invention, a bundle pattern is a special case of a transform in which a set of resources (e.g., A and B) are replaced by a bundle of the resources (e.g., bundle AB). Additional patterns, such as promotion patterns and incentives, can define other actions. For example, for a promotion, the promotion pattern can specify which products in a raw package or bundled package qualify for an offered promotion, such as free software. The use of a promotion pattern to determine whether a raw package or bundled package qualifies for a promotion is provided by way of example only, and it should be understood that the bundle pattern can specify any arbitrary action. Patterns such as promotion patterns that do not bundle or transform the resources or bundles already in a raw package or bundled package will be referred to as nontransform patterns. Though, it should be noted, nontransform patterns can add resources to a raw or bundled package.

FIG. 3A illustrates one embodiment of a generic bundle pattern. FIG. 3B illustrates two bundle patterns that will be used for purposes of explanation in subsequent examples. Bundle pattern 74 (e.g., BP1) defines a bundle that contains resources A,B and Resource Class C. Resource ClassC can contain resources C or C′. Bundle pattern 74 is associated with anchors {A,ResourceClassC} or {A,B}, In this example, BP1 can be applied to raw packages that contain resources A,B or A,C or A,C′. Bundle pattern 76 (e.g., BP2) defines a bundle that contains resources B,C and D and is associated with anchor {B,D}, meaning that resources B and D must be present for BP2 to apply. For the sake of simplicity, other information, such as rules, pricing information and cardinalities are not shown. Table 4 includes additional examples of defined bundle patterns and associated anchors for the defined bundle patterns BP1-BP12.

TABLE 4

| Bundle Pattern | Resource Components | Anchors |
|---|---|---|
| BP1 | A, B, Resource Class C | {{A, B}, {A, Resource |
| | | ClassC}} |
| BP2 | B, C, D | {{B, D}} |
| BP3 | G, H | {{G}} |
| BP4 | H, I, J | {{H}} |
| BP5 | D, E | {{D}} |
| BP6 | L, M, N | {{M, N}} |
| BP7 | N, P | {{N}} |
| BP8 | A, L, K | {{A, K}} |
| BP9 | C, K, N, A | {{K}} |
| BP10 | Resource ClassC, O, K, B | {O} |
| BP11 | OK | {K} |
| PB12 | K | {K} |

The bundle patterns in Table 4 are provided by way of example only, and it should be understood that arbitrarily complex patterns can be defined for a given set of resources.

FIG. 4 is flow chart illustrating one embodiment of a method for determining which patterns apply to a raw package. For the sake of explanation, FIG. 4 will be discussed in context of the examples provided in Table 4. At step 80 a raw package can be received. The raw package represents a set of resources that have been selected to meet a user's needs. In one embodiment of the present invention, each defined pattern (e.g., bundle, transform or nontransform) can be applied to the raw package. However, if there are a large number of defined patterns, this can lead to significant processing times. Therefore, at step 82, the patterns potentially applicable to the raw package can be determined. This can be done, for example, by selecting the patterns that are associated with resources of the raw package. Continuing with the previous example and assuming resources A-P and C′ are available, assume that the associations listed in Table 5 are established for the example bundle patterns:

TABLE 5

| Resource | Bundle Pattern |
|---|---|
| A | BP1, BP8, BP9 |
| B | BP1, BP2, PB10 |
| C | BP1, BP2, BP9, BP10 |
| C′ | BP1, BP10 |
| D | BP2, BP5 |
| E | PB5 |
| F | BP12 |
| G | BP3 |
| H | BP3, BP4 |
| I | BP4 |
| J | BP4 |
| K | BP8, BP9, BP10, BP11 |
| L | BP6, BP8 |
| M | BP6 |
| N | BP6, BP7, BP9 |
| O | BP10, BP11 |
| P | BP7 |

Using the example associations above, assuming raw package S₁: S₄ contains resources A, B, B, D, G, H, H, M, N, N, the initially applicable bundle patterns from Table can include BP1, BP2, BP3, BP4, BP5, BP6, BP7, BP8, BP9, and BP10. BP11 and BP12 would not be applicable because for BP 11, neither O nor K is contained in raw package S₁:S₄ and for BP 12, neither K is not contained in raw package S₁:S₄.

This gives an initial set of ten bundle patterns that apply to raw package S₁:S₄. By indexing resources to bundle patterns, the number of bundle patterns from the bundle pattern catalog that must be compared to a particular raw package is reduced, thereby increasing processing efficiency. It should be noted that indexing, in one embodiment of the present invention, can account for resource classes. For example, bundle pattern BP1 includes a component for resource class C. Therefore, resource C, which falls in resource class C, would be indexed to bundle pattern BP1. Additionally, if C′ falls in resource class C, C′ can be indexed to bundle pattern BP1.

In one embodiment of the present invention, indexing of resources to bundle patterns can be achieved through relational database indexing or any other means known in the art. Additionally, resources can be indexed to transforms and additional patterns in a similar manner. In another embodiment of the present invention, each resource can be stored with an associated array of potentially applicable bundle patterns. The array can also include the potentially-applicable bundles for the resource class into which the particular resource falls. To select the potentially applicable bundle pattern in step 82, a Set, in one embodiment of the present invention, can be used (e.g., by bundling module 46 of FIG. 2) to union the arrays for the resources into a single set. One example of selecting applicable bundles is illustrated in the following pseudo-code:

```
  Set partsSet;
  Set bundleSet;
  for (j = 0; j<parts.length; j++ {
    If (!partsSet.contains(part[j].id){
      partsSet.add(parts[j].id);
      List classifiers =
parts[j].classifiers( );
      partSet.addAll(classifiers);
  bundleSet.addAll(part[j].indexedBundles( ));
    Vfor (k = 0; k<classifiers.length;k++) {
  bundleSet.addAll(classifiers[k].indexedBundles( ));
      }
    }
  }
}
```

The above example provides a set of potentially applicable patterns, represented as bundleSet. Potentially applicable transforms and nontransform patterns can be indexed and selected in a similar manner.

In addition to selecting a set of potentially applicable patterns based on indexing the resources to the patterns, the applicable patterns can, at step 84, be further filtered based on anchors. For example, using the anchors listed in Table 4, the following bundle patterns would apply to S₁:S₄ containing resources A, B, B, D, G, H, H, M, N, N: BP1, BP2, BP3, BP4, BP5, BP6 and BP7. BP8 and BP9 would not apply because S₁: S₄ does not include K. Therefore, the number of bundle patterns that will be applied to S₁:S₄ has been reduced from twelve to seven, thereby reducing the required processing time.

To further reduce processing time, the patterns can be further evaluated based on rules (step 86). The rules can specify contextual information that must be met for a particular bundle pattern to apply. For the sake of simplicity, no rules were established for BP1-BP12, so step 86 will not apply. The application of anchors and filters can reduce the potentially applicable set of patterns to a more manageable number.

The applicable patterns can be partitioned into the set of patterns that bundle or change the resources in the raw package (e.g., bundle patterns and transforms) and nontransform patterns that define actions other than changing resources (e.g., promotion patterns). In step 88, transforms and bundle patterns can be separated from nontransform patterns. This can be done because, generally, the order in which nontransform bundle patterns are applied does not matter. However, the order in which bundle patterns and transforms that share common components are applied may matter in a given case. Partitioning of patterns between bundling patterns and transforms and nontransform patterns can be done, for example, based on metadata associated with the patterns. Continuing with the previous example, assume all the patterns defined are bundle patterns. Therefore, control can pass to step 90.

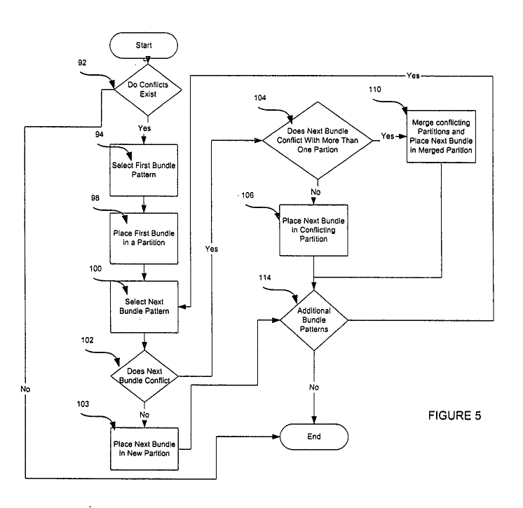

Bundle patterns that contain common components have the potential of conflicting with one another, so that only a subset of them may be applied at once. However, bundle patterns that do not share common components can be applied without regard to one another. Partitioning the set of applicable packaging bundle patterns into conflict sets can reduce the processing requirements and can permit parallel computation. One method for generating conflict sets is described in conjunction with FIG. 5.

To summarize, every available pattern can be selected for application to a raw package. However, this can lead to significant processing requirements for a system that has a large number of resources and/or patterns. Therefore, the number of patterns can be reduced by only considering those patterns associated with the resources in the raw package (step 82), filtering those patterns based on anchors (step 84) and rules (step 86), partitioning the applicable patterns into bundle/transform patterns and nontransform patterns (step 90) and/or generating conflict sets based on the bundle/transform patterns (step 92).

FIG. 5 is a flow chart illustrating one embodiment of a method for generating conflict sets for bundle patterns. Again, the example of bundle patterns BP1-BP7 will be used that have the components listed in Table 4. At step 92, it is determined whether conflicts exist between the bundle patterns. In this case, for example, both BP1 and BP2 use the resource B, and, therefore, potentially conflict. At step 94 a bundle pattern is selected. The bundle pattern can be selected randomly, based on a predetermined factor or in any other manner known in the art. For the sake of example, assume BP1 is chosen.

BP1 is placed in a partition (step 98). At step 100, a next bundle pattern, say BP2, is chosen. Step 102 determines whether the next bundle pattern conflicts with any of the bundle patterns in the established partitions. If the next bundle pattern conflicts with a bundle pattern in an established partition control passes to step 104. If the next bundle pattern does not conflict with a bundle pattern in an established partition, the next bundle pattern is placed in a new partition (step 103). In this case BP2 and BP1 have the common component of resource B and therefore conflict. If the next bundle pattern conflicts with bundle patterns in only one partition (step 104), the next bundle pattern is placed in that partition (step 106). Thus, BP2 is placed in the same partition as BP1. If the next bundle pattern conflicts with bundle patterns in multiple partitions, those partitions are merged into a single partition and the next bundle pattern is placed in the merged partition (step 110). The process can continue for each applicable packaging bundle pattern (step 114).

Following the flow chart of FIG. 5 and continuing with the examples of BP3-BP7, BP3 can be placed in a new partition as it does not conflict with BP1 or BP2; BP4 conflicts with BP3 and can be placed in the same partition as BP3; BP5 conflicts with BP2 and can be placed in the same partition as BP1 and BP2; BP6 does not conflict with any of the previously selected bundle patterns and can be placed in a new partition; and BP7 conflicts with BP6 and can be placed in the same partition as BP6. This yields the following conflict partitions or conflict sets:

{{BP1,BP2,BP5},{BP3,BP4},{BP6,BP7}}. The corresponding resources for each conflict set are {{A,B,C,Resource Class C, D, E}{G,H,I,H},{L,M,N,P}.

The resources for the conflict partitions can now be bundled independently of one another, and then combined after bundling to generate various bundled packages. In one embodiment of the present invention, the size of the result set from applying the bundle patterns is a product of the cardinality of the various partitions. If the order of applying the bundle patterns is independent, the size of the result set will be 2ⁿ, with n being the number of bundle patterns. For BP1-BP7 this gives a result set of 128. If the order of applying the bundles is a factor, the size of the result set is the sum of the permutations of the different combinations of partitions. For example, for the partition {BP1,BP2,BP5}, there are sixteen permutations, including: { }, {BP1}, {BP2}, {PB5}, {BP1,BP2}, {BP2,BP1}, {BP1,BP5}, {BP5,BP1}, {BP2,BP5}, {BP5,BP2}, {BP1,BP2,BP5}, {BP1,BP5,BP2}, {BP2,BP1,BP5}, {BP2,BP5,BP1}, {BP5,BP1,BP2}, {BP5,BP2,BP1}. For the partition {BP3,BP4} and the partition {BP6,BP7}, there are four permutations each. There are 400 combinations of the permutations from each partition.

Thus, there are only 128 results to be considered if the order in which bundle patterns are applied does not matter, and 400 results if order does matter. Without taking conflict sets into account, on the other hand, the result set would based on the cardinality of {BP1, BP2, BP3, BP4, BP5, BP6, BP7}, leading to 13,700 possible permutations.

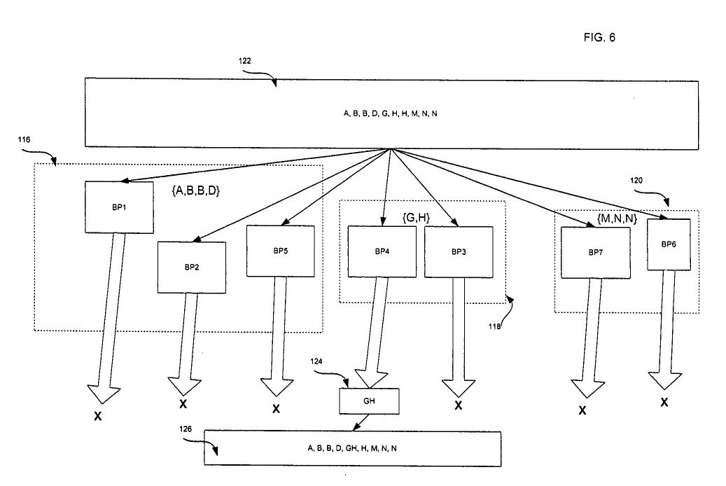

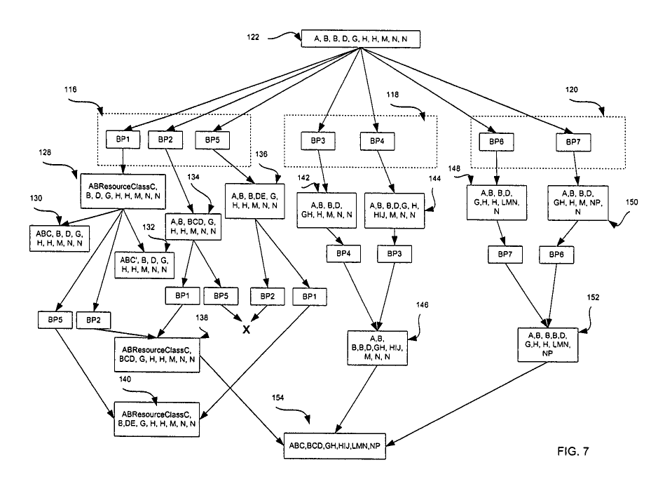

Bundled packages can be generated by applying the selected bundle patterns, in this case BP1-BP7, to the raw package. Bundle matching can, in one embodiment of the present invention, comprise a regular expression matching algorithm between the raw package and the bundle patterns with subsumptions for resource classes. If a bundle pattern is applicable, the bundle pattern components that match the resources in the bundle pattern can be put together in a bundle pattern/resource binding, and the bound resources can be removed from further consideration. If only exact matches are allowed, only bundles that include each resource specified by the bundle pattern will be generated. If non-exact matches are allowed, bundles can be generated that introduce new products into the bundled package. FIG. 6 and FIG. 7 illustrate exact and non-exact matching using the example of a raw package containing resources A, B, B, D, G, H, H, M, N, N and bundle patterns BP1-BP7 listed in table 4.

FIG. 6 is a diagrammatic representation of generating bundled packages requiring exact matching according to one embodiment of the present invention. In the example of FIG. 6, bundle patterns BP1 through BP7 are applied according to the conflict sets discussed in conjunction with FIG. 5. In FIG. 6, the set of applicable bundle packages is split into conflict partition 116, 118 and 120. The resources corresponding to each conflict partition are also shown. Conflict partition 116 includes bundle patterns BP1, BP2 and BP5, conflict partition 118 includes bundle patterns BP3, BP4, and conflict partition 120 includes bundle patterns BP6 and BP7. The bundle patterns can be compared to raw package 122. Because raw package 122 does not include the resource C or a member of resource class C, the comparison between BP1, BP2 and raw package 122 will not yield a bundle. Similarly, the application of BP4, BP6 and BP7 will not yield a bundle. However, because raw package 122 contains G and H, the application of BP3 will yield GH bundle 124, giving bundled package 126 that contains A, B, B, D, GH, H, M, N, N.

The bindings created by the application of a bundle pattern can be denoted, for the sake of explanation, as (part:bundlepattern.bundledresoruce). So, for the application of BP3 as described above, the bindings will be {(G:BP3.G),(H:B3.H)}. The result expression can include the bindings and the resources still available for binding. Accordingly, the result expression for the application of BP3 can be:

{(G:BP3.G),(H:B3.H)},{A,B,D,H,M,N,N}.

FIG. 7 is a diagrammatic representation of generating a bundled packages not requiring exact matching according to one embodiment of the present invention. With nonexact or partial matching, a bundle pattern can potentially add resources that are not contained in the raw package. However, in one embodiment of the present invention, the bundle patterns can be constrained to bundle a particular resource that is contained in the raw package only once, as will be illustrated below when BP5 is applied after BP2 or BP2 after BP5. In the example of FIG. 7, bundle patterns BP1 through BP7 are applied according to the conflict sets discussed in conjunction with FIG. 5. In FIG. 7, a set of bundle packages is split into conflict sets 116, 118 and 120. Conflict set 116 includes bundle patterns BP1, BP2 and BP5, conflict set 118 includes bundle patterns BP3, BP4, and conflict set 120 includes bundle patterns BP6 and BP7. The bundle patterns can be compared to raw package 122 as described in conjunction with FIG. 6. In this case, however, partial matching is permitted, meaning that a bundled package can be generated even if the raw package does not contain each of the resources required by the bundle pattern. For example, when BP1 is applied, potential bundled package 128 can be generated even though the raw package does not contain a resource for resource class C. If resource class C contains C and C′, bundled package 128 will lead to bundled packages 130 and 132. The bindings associated with bundled package 128 can be as follows:

{(A:B1.A),(B:B1.B), (_:B1.ResourceClassC)},{B,D,G,H,H,M,N, N}. The “_” represents that that resource is not present in the raw package, but was introduced as part of a bundle.

Continuing with the previous example, application of BP2 can lead to potential bundled package 134 with associated bindings {(B:BP2.B),(_:BP2.C),(D:BP2.D)},{A,B,G,H,H,M,N,N} and application of BP5 can lead to potential bundled package 136 with associated bindings {(D:BP5.D), (_:BP5.E)}, {A,B,B,G,H,H,M,N,N}. In this case bundled package 136 can suggest a bundle that contains resource E, even though resource E was not included in the original solution to the user's needs (e.g., was not included in the raw package).

The bundled packages generated by one bundle pattern can then be compared to other bundle patterns in the same conflict set partition. In this case, for example, bundled package 128 can be compared to BP2 and BP5 to generate bundled package 138 and bundled package 140; bundled package 134 can be compared to BP1, which will also generate bundled package 138, and BP5, which will not generate a new bundled package because D has already been bundled; bundled package 136 can be compared to BP2, which will not generate a new bundled package (because D has already been bundled), and BP1, which will generate bundled package 140. Iterations through a conflict set partition can continue until all the permutations of bundle patterns in a partition have been applied to the raw package. In the case of FIG. 7, however, additional iterations of applying bundle patterns in partition 116 will not lead to any addition bundled packages. The bindings (with remaining resources) resulting from the application of partition 116 in the present example are:

{(A:BP1.A),(B:BP1.B),(_:BP1.ResourceClassC)},{B,D,G, H,H,M,N,N};

{(B:BP2.B),(_:BP2.C),(D:BP2.D)},{A,B,G,H,H,M,N,N};

{(D:BP5.D),(_:BP5.E)},{A,B,G,H,H,M,N,N};

{(A:BP1.A),(B:BP1.B),(_:BP1.ResourceClassC) (B:BP2.B), (_:BP2.C),(D:BP2.D)},{G,H,H,M,N,N}; and

{(A:BP1.A),(B:BP1.B),(_:BP1.ResourceClassC), (D:BP5.D),(_:BP5.E},{B,G,H,H,M,N,N}.

If there are two resources for Resource Class C, C and C′, the bindings can be:

{(A:BP1.A),(B:BP1.B),(_:BP1.C)},{B,D,G,H,H,M,N,N};

{(A:BP1.A),(B:BP1.B),(_:BP1.C′)},{B,D,G,H,H,M,N,N};

{(B:BP2.B),(_:BP2.C),(D:BP2.D)},{A,B,G,H,H,M,N,N};

{(D:BP5.D),(_:BP5.E)},{A,B,G,H,H,M,N,N};

{(A:BP1.A),(B:BP1.B),(_:BP1.C) (B:BP2.B), (_:BP2.C),(D:BP2.D)},{G,H,H,M,N,N}; and

{(A:BP1.A),(B:BP1.B),(_:BP1.C′) (B:BP2.B), (_:BP2.C),(D:BP2.D)},{G,H,H,M,N,N};

{(A:BP1.A),(B:BP1.B),(_:BP1.C), (D:BP5.D), (_:BP5.E},{B,G,H,H,M,N,N}; and

{(A:BP1.A),(B:BP1.B),(_:BP1.C′), (D:BP5.D), (_:BP5.E},{B,G,H,H,M,N,N}.

In the example of FIG. 7, the application of the bundle patterns in partition 118 will yield bundled package 142, bundled package 144 and bundled package 146. The bindings resulting from the second partition can be:

{(G.BP3.G),(H:BP3.H)},{A,B,B,D,H,M,N,N};

{(H.BP4.G),(_:BP4.I),(_:BP4.J)},{A,B,B,D,H,M,N,N}; and

{(G.BP3.G),(H:BP3.H), H.BP4.G),(_:BP4.I),(_:BP4.J)}, {A,B,B,D,M,N,N}.

Further in example of FIG. 7, the application of the bundle patterns in partition 120 will yield bundled package 148, bundled package 150 and bundled package 152. The binding resulting from partition 120 can be:

{(_.BP7.L),(M:BP7.M),(N:BP7.N)},{A,B,B,D,G,H,H,N};

{(N.BP6.N),(_:BP6.P)},{A,B,B,D,G,H,H,M,N}; and

{(_.BP7.L),(M:BP7.M),(N:BP7.N),(N.BP6.N),(_:BP6.P)}, {A,B,B,D,G,H,H}.

According to one embodiment of the present invention, additional bundled packages can be generated taking the union of the bindings and the intersection of the nonbound elements. For example, the bindings for bundled package 138 can be combined with the bindings of bundled package 146 and bundled package 154 to generate bundled package 154 with the following associated bindings (using C as the member of resource class C):

{(A:BP1.A),(B:BP1.B),(_:BP1.C) (B:BP2.B), (_:BP2.C), (D:BP2.D), (G.BP3.G),(H:BP3.H), (H.BP4.G),(_:BP4.I), (_:BP4.J),

(_.BP7.L),(M:BP7.M),(N:BP7.N),(N.BP6.N),(_:BP6.P)},{ }.

Additional bundled packages can be generated in this manner by combining bundle packages from different conflict partitions. Using the eight results from partition 116 to account for class members C and C′, the three results from partition 118 and three results partition 120, 143 bundled packages can be generated along with the original raw package.

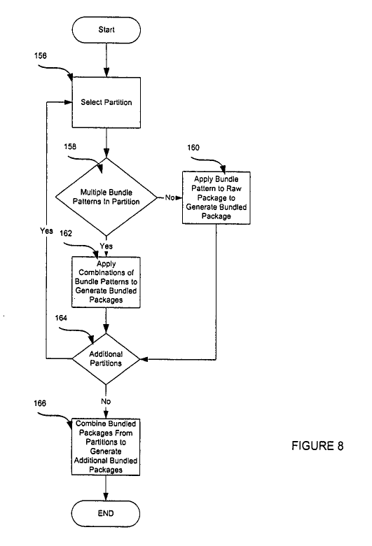

FIG. 8 is a flow chart for generating bundled packages according to one embodiment of the present invention. At step 156 a partition from the conflict set is chosen. If no conflict sets were established then each applicable bundle pattern can be considered as being in the same partition. If there is only one bundle pattern in the partition, as determined at step 158, the raw package can be compared to that bundle pattern at step 160 and control can pass to step 164. If there are multiple bundle patterns in the partition, combinations of the bundle patterns can be applied to generate each possible bundled package using either full or partial matching. Alternatively, permutations of bundle patterns can be applied to generate each possible bundled package, with duplicate bundled packages not being counted. If there are multiple partitions, as determined at step 164, steps 156-162 can be repeated for each partition. At step 166 a set of additional bundled packages can be generated by combining the bundled packages from each partition. As described in conjunction with FIG. 7, this can be done, in one embodiment of the present invention, by taking the union of bindings and the intersection of non-bound resources for each bundled packages being combined.

In the examples of FIG. 6, FIG. 7 and FIG. 8, it was assumed that order of application of bundle patterns did not matter. In general, order may not matter if bundle patterns do not compete with one another to bundle the resources. However, if bundle patterns do compete to bundle the same resource, then order may matter. For example, if a first bundle pattern (e.g., BP15) defines a bundle that bundles resource A and any number of resource B's and a second bundle pattern (e.g., BP16) defines a bundle of any number of BC bundles, the bundle patterns compete to bundle available resource B's. In other words, both of these bundle patterns will try to bundle as many B components as possible. If the different bundle patterns are allowed to bundle as many Bs as are available, then different results are generated depending on the order of application. If for example the raw package contains resources A,B,B,B,C,C, and BP15 is applied first and then BP16, the following bindings result:

{(A:BP15.A),(B:BP15.B),(B:BP15.B),(B:BP15.B)},{C,C}

If, however, BP16, which tries to bundle as many BC bundles as possible, is applied first, the following bindings result:

{(B:BP16.B),(B:BP16.B),(C:BP16.C),(C:,BP16.C),(A:BP1 5.A), (B:BP15.B)}, { }.

If each bundle pattern is allowed to bundle less than the maximum number of resources, then several other bindings can result. For example, when BP15 is applied, it can result in, among other bindings:

{(A:BP15.A),(B:BP15.B)}{B,B,C,D}.

For very complex bundles, the potential variations of matching optional and multiple copies of resources is very large, 2ⁿ, where “n” is the number of resources in the raw package that might match. Thus, a bundle pattern that has 20 optional resources that might match will result in approximately one million possible bundled packages. Combining the bundled packages with other bundled packages increases the number. In one embodiment of the present invention, to reduce the computational requirements for dealing with bundle patterns that have optional resources is to have each such bundle pattern match the maximum number of components that it can. Thus the bindings generated by BP15 for example would be:

{(A:BP15.A),(B:BP15.B),(B:BP15.B),(B:BP15.B)},{C,C}.

Furthermore, in the examples of FIG. 6, FIG. 7 and FIG. 8, bundle patterns were applied to resources. However, it should be noted that bundle patterns can apply to bundles as well. In other words, bundled packages can be compared to bundle patterns that specify bundling of bundles with other bundles and/or resources.

In the above example, each resource that matched a bundle pattern was considered an equally good fit. However, in some cases, while two resources may satisfy a component of the bundle pattern, they may not be equally satisfactory. Therefore, the resources can be associated with resource ratings to account for this. For example, if a bundle pattern requires that the total channels provided by ports in a bundle not exceed 24, this constraint can be addressed by rules, as discussed in conjunction with FIG. 3. However, it may be that several bundles meet the constraints of the rule but have more or less channels (e.g., 24 versus 16 channels). The ports to be bundled can be given ratings, for example rating a 24 channel port higher than a 16 channel port. This can allow the final bundled packages to be more easily evaluated with respect to a user's defined needs.

FIG. 9 is a diagrammatic representation of a system similar to that of FIG. 2 in which solution engines (e.g., DN engine 32, DIA engine 34, WH engine 36, LDV engine 38 and LV engine 40) can generate a set of solutions 31 based on a set of resources 27 and user inputs 30. A raw packaging module 42 can generate raw packages 44 by taking the cross products of solutions generated by the various engines and provide raw packages 44 to a bundling module 46. Bundling module 46 can compare raw packages 44 to bundle patterns 48 to generate bundled packages. In the system of FIG. 9, however, bundling module 46 can also apply transforms to generate transformed raw package 176 and/or transformed bundled packages 180.

Transformations are performed similar to generation of bundled packages in that a set of resources from, for example, a raw package are compared to a pattern. Rather than specifying a particular bundle however, the transform can specify that one or more of the resources should be replaced with other resources. For example, if a raw package has resources A, B, G, D, a bundle pattern can specify that G and D should be replaced with C. The transformed raw package can then be bundled by bundling module 46 using resources A, B, C. In another embodiment of the present invention, the transform can specify that bundled resources from bundled packages can be replaced with other resources. For example, a transform can specify that if AB is found, AB should be replaced with E. As would be understood by one of ordinary skill in the art, a transform, in one embodiment of the present invention, can define a set of bindings and a set of replacements for some or all of the bound resources. A transform may be applied multiple times to a set of resources, resulting in several distinct transformations.

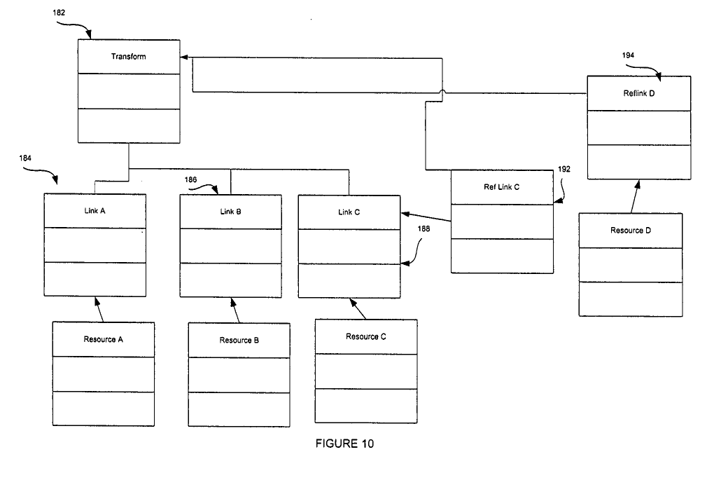

FIG. 10 is a diagrammatic representation of an example transform 182 for replacing resource C with resource D, when a bundle of ABC is found. Transform 182 includes a set of links to resources to be found (e.g., link 184 to resource A, link 186 to resource B, and link 188 to resource C). Transform 182 also includes reflink 192 to link C 188 and reflink 194 to resource D. Resource A and resource B will be maintained after the transform. However, the empty reference to Link C indicates that Link C will not be maintained. Instead, transform 182 includes a reflink 194 to resource D, meaning that resource D will be added to replace resource C if the ABC pattern is found in a bundled package.

Transforms can also be used to share resources between multiple solutions. In the telecommunications industry for example, a DN solution and a DIA solution may each require loops and/or ports. Thus for example, both S₁ and S₄ (from FIG. 2) may include a loop. However, only one loop may be required to implement both a data network and direct internet access. Transforms can be used, in one embodiment of the present invention to achieve resource sharing, such as loop or port sharing. A transform can be applied to eliminate one of the loops or ports. Rules associated with the transform can ensure that the transform is applied correctly to the ports or loops. Finally, to encourage that the transform produces the best set of loops and/or ports, rating expressions can be applied for matching. It should be noted that the structure of FIG. 10 is provided by way of example only, and, as would be understood by those of ordinary skill in the art, any data structure or data storage format can be used to express transform replacements.

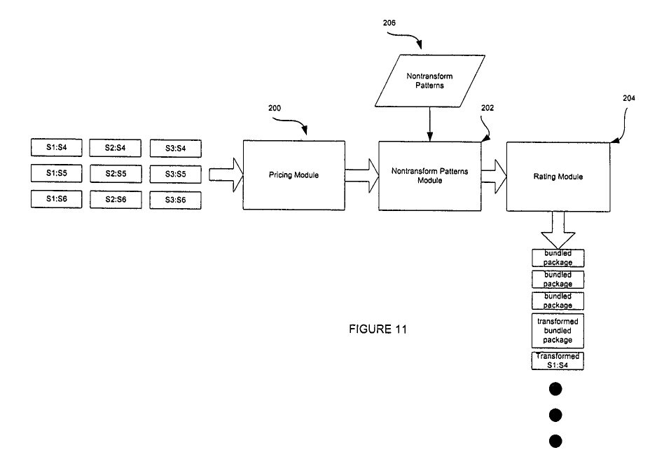

FIG. 11 is a diagrammatic representation of post-bundling processing according to one embodiment of the present invention. In the example of FIG. 11, the raw packages (or those selected for further processing based on their rating), the transformed raw packages, the bundled packages (including transformed bundled packages and/or non-transformed bundled packages) are priced. For raw packages and transformed raw packages the price can simply be the aggregate of the resource prices of the package. For transformed and non-transformed bundled packages, the bundled packages can be associated with pricing/discount information specified by pricing/discount data associated with the resources in the bundle pattern. For example, pricing/discount data (such as the pricing/discount data 72 of FIG. 3A) can specify, that the bundle AB of resource A and resource B should cost $15. Alternatively, the pricing/discount data can specify that, in bundle AB, the price of A is discounted 10% while the price of B is discounted 14%. The price for each bundled package can be the price for the bundle (e.g., $15) or price of A*0.1 plus the price of B*0.14, plus the unit price of all the remaining resources in the bundled package. If there are multiple bundles in the bundled package, the package price can be the price of each bundle plus the unit price of each unbundled resource.

Nontransform module 202 can apply nontransform bundle patterns 204 to the raw packages and bundled packages. As discussed in conjunction with FIG. 3A, nontransform bundle patterns can specify an arbitrary action based on resources or bundles that match the nontransform pattern. One example of a nontransform bundle pattern can be promotions. As an example, using the example of FIG. 7 with a bundled package containing A, B, B, GH, H, M, N, N, and the following binding:

{(G:BP3.G),(H:BP3.H)},{A, B, B, GH, H, M, N, N}

A nontransform pattern (e.g., BP17) can specify that if GH and A are found, then resource Q should be offered for free. The bindings for the application of BP17 can be specified as:

(((G:BP3.G):BP17.G),((H:BP3.H):BP17.H), A:BP17.A)}, {A, B, B, GH, H, M, N, N}.

As additional promotions are applied, more bindings can be composed with existing bindings.

According to one embodiment of the present invention, rating module 204 can rate the raw packages (transformed and/or nontransformed) and bundled packages (transformed and/or nontransformed). Rating module 204 can initially rate the packages without respect to cost. In this step, rating module 204 can taking the generalized mean of the relative “happiness” values rating for the solutions in a package. In the case of direct internet access, happiness can be based on such traits as reliability, security, bandwidth, and other such factors known in the art. For an arbitrary set of trait values, the solution rating for a particular solution (e.g., S₁) can be:

SolutionRating=[(h₁^{α}+h₂^{α}+ . . . +hₙ^{α})/(n)]´(1/α) [EQ. 1]

In EQ. 1, h₁, h₂, hₙ represents the happiness values for various traits of a solution. The happiness values can be based, for example, on user input. α is a constant value that varies the generalized mean effect (an α of 1 produces an arithmetic mean).

Since each raw package and bundled package is made up from multiple solutions, the package rating can be the arithmetic mean of the solutions ratings that make up the package. For example, for a bundle package derived from the raw package S₁:S₄, the package rating (PackageRating) is equal to:

(SolutionRating(S₁)+SolutionRating(S₄))/2 [EQ. 2]

Since the cost of a bundled package may differ from the sum of the individual solutions, the overall package rating (OverallPackageRating) is computed by factoring in cost. In one embodiment of the present invention, this can be done by calculating a SolutionCostHappinessRating for each solution in the same manner as the SolutionRating, but including a cost happiness (an additional hₙ value). A PackageCostHappiness rating is calculated from the SolutionCostHappinessRating in the same manner the PackageRating is calculated from the SolutionRatings. The OverallPackageRating can be calculated as follows:

w₁*PackageRating+w₂*packageCostHappiness)/((w₁+w₂) [EQ. 3]

In EQ. 3, w₁ and w₂ represent the relative weights for a package both with and without costs. The OverallPackageRatings can be used to sort the packages for recommending to a user. It should be noted that the example rating scheme described above is provided by way of example and any or no rating scheme may be used to rate raw and bundled packages.

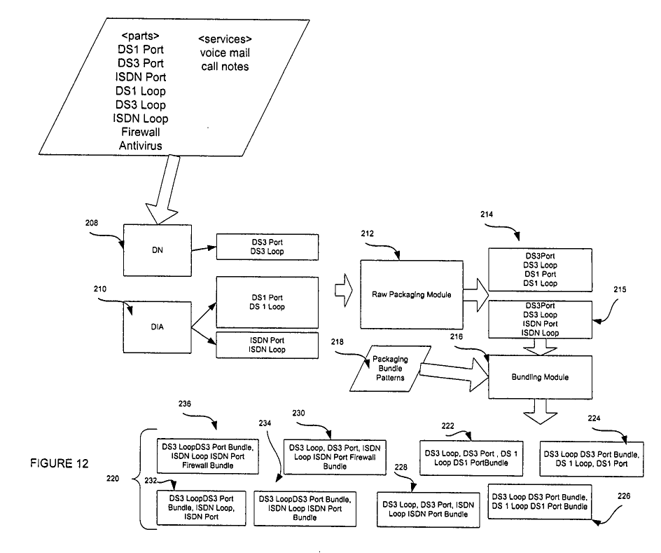

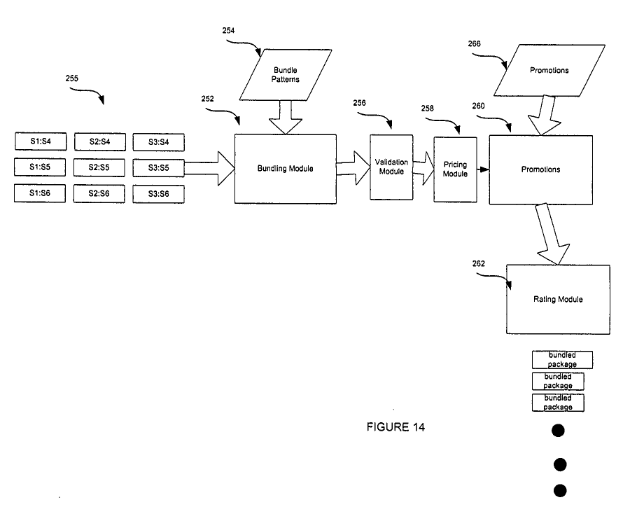

FIG. 12 provides an example of bundling in the telecommunications industry. The example of FIG. 14 includes the application of bundling patterns and nontransform patterns. The available resources 206 include the following products: DS1 Loop, DS3 Loop, a DS1 port, a DS3 port, an ISDN subscriber loop, an ISDN port, a firewall, antivirus software, voice mail and call notes. Examples of relative prices for the products are listed in Table 6.

TABLE 6

| Resource | Price |
|---|---|
| DS1 Port | 2 |
| DS1 Loop | 2 |
| DS3 Port | 3 |
| DS3 Loop | 3 |
| ISDN Port | 1.5 |
| ISDN subscriber loop | 1.5 |
| Firewall | 1 |
| Antivirus | 1 |
| Voice Mail | .5 |
| Call Notes | .5 |

For this example, assume a new user indicates that he or she wishes to install a data network and have direct internet access. A DIA engine 208 can propose S₁ that includes a DS1 port and DS1 loop and S₂ that includes an ISDN port and an ISDN subscriber loop. A DN engine 210 can propose S₃ that has a DS3 Loop and a DS3 port. Raw package module 212 can generate raw package 214 and raw package 215 by taking the cross products of the solutions to meet the user's needs. These can then be passed to bundling module 216.

Table 7 provides examples of available bundling patterns and associated data defined for the example of FIG. 14:

TABLE 7

| Bundle Pattern | Bundle | Anchor | Rules | Price |
|---|---|---|---|---|
| BP18 | DS1 Loop DS1 | DS1 Loop | | 3 |
| | Port | | | |
| BP19 | DS3 Loop | DS3 Loop | | 5 |
| | DS3 Port | | | |
| BP20 | ISDN Loop | ISDN Loop | | 10% |
| | ISDN Port | | | discount |
| | | | | on Loop |
| | | | | and Port |
| BP21 | ISDN Loop | ISDN Loop | Only New | 3 |
| | ISDN Port | ISDN Port | Users | |
| | Firewall | | | |
| BP22 | DS1 Loop | Call notes | | 4 |
| | Callnotes | Voicemail | | |
| | Voicemail | DS1 Loop | | |
| BP23 | DS3 Loop | DS3 Loop | Only | 5.5 |
| | DS3 Port | | Previous | |
| | | | Users | |

In this example, BP18, BP19, BP22 and BP23 can be considered initially applicable to raw package 214 and BP19, BP20 and BP21 can be considered initially applicable to raw package 215. However, bundling module 216 can filter the bundle patterns based on anchors and rules. In this case BP22 can be filtered out based on its anchors (e.g., voicemail and call notes do not appear in the raw packages) and BP23 can be filtered out based on the fact that the user is a new user.

Bundling module 216 can then establish conflict partitions for each raw package. With respect to raw package 214, BP18 and BP19 do not conflict, so each can be placed in its own partition. With respect to raw package 215, BP20 and BP21 conflict. Therefore BP20 and BP21 can be placed in one conflict partition and BP19 in another.

Applying BP18 to raw package 214 can yield the following bindings with remaining resources:

{(DS1Loop:BP18.DS1Loop),(DS1Port:BP18.DS1Port)}, {DS3Port,DS3Loop} (e.g., bundled package 222)

Applying BP19 to raw package 214 can yield:

{(DS3Loop:BP19.DS3Loop),(DS3Port:BP19.DS3Port)}, {DS1Port,DS1Loop} (e.g., bundled package 224)

Combining the solutions from the conflict sets can yield:

{(DS1Loop:BP18.DS1Loop),(DS1Port:BP18.DS1Port), (DS3Loop:BP19.DS3Loop),(DS3Port:BP19.DS3Port)},{ } (e.g., bundled package 226).

With respect to raw package 215, applying the first conflict partition applies BP20 and BP21. The application of BP20 can yield:

((ISDNLoop:BP20.1SDNLoop),(ISDNPort:BP20.ISDNPort) }, {DS3Port,DS3Loop} (e.g., bundled package 228);

and the application of BP21, assuming partial matches are permitted, can yield:

{(ISDNLoop:BP21.1SDNLoop),(ISDNPort:BP21.1SDNPort),(_:BP 21.Firewall)},{DS3Port,DS3Loop} (e.g., bundled package 230).

Applying additional combinations of BP21 and BP20 will not result in additional bundled packages because ISDN port and ISDN loop in raw package 215 are consumed by the first applied bundle pattern of BP21 or BP20.

Moving to the next conflict partition for raw package 215, bundling module 216 can apply BP19 to yield:

{(DS3Loop:PB19.DS3Loop),(DS3Port:PB19.DS3Port)},{ISDN Loop, ISDN Loop} (e.g., bundled package 232).

Combining results across the conflict partitions can yield:

{(ISDNLoop:BP20.1SDNLoop),(ISDNPort:BP20.1SDNPort), (DS3Loop:PB19.DS3Loop),(DS3Port:PB19.DS3Port)},{ } (e.g., bundled package 234); and

{(ISDNLoop:BP21.1SDNLoop),(ISDNPort:BP21.1SDNPort),(_:B P21.Firewall),(DS3Loop:PB19.DS3Loop),(DS3Port:PB19.DS3P ort)},{ } (e.g., bundled package 236).

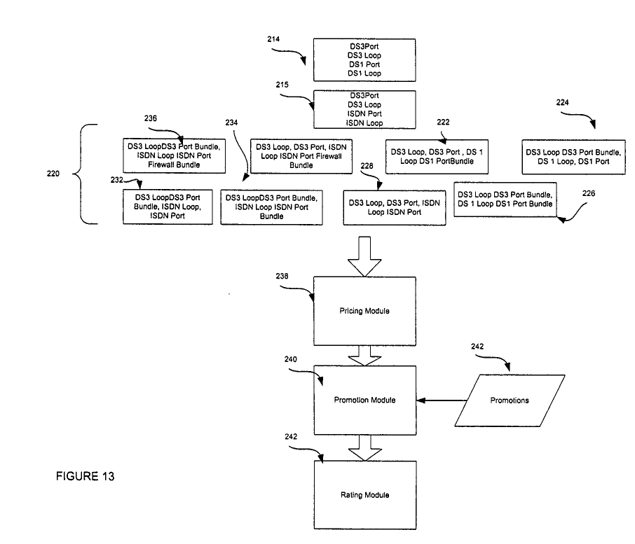

FIG. 13 illustrates one embodiment of post bundling processing, according to one embodiment of the present invention. In FIG. 13, the raw packages 214 and 215 and bundled packages 220 can be passed to pricing module 238. Pricing module 238 can determine a price for each bundled package and raw package using, for example, the pricing information in Table 6 and Table 7. Table 8 is an example table of prices that can be calculated based on Table 6 and Table 7:

TABLE 8

| Package Contents | Price |
|---|---|
| DS1 Loop, DS1 Port, DS3 Port, | 10 |
| DS3 Loop (e.g., raw package | |
| 214) | |
| DS3 Loop, DS3 Port, ISDN Loop, | 9 |
| ISDN Port (e.g., raw package | |
| 215) | |
| DS1 Loop DS1 Port Bundle, DS3 | 9 |
| Loop, DS3 Port (e.g., raw | |
| bundled package 222) | |
| DS3 Loop DS3 Port Bundle, DS1 | 9 |
| Loop, DS1 Port (e.g., raw | |
| bundled package 224) | |
| DS3 Loop DS3 Port Bundle, DS1 | 8 |
| Loop DS1 Port Bundle (e.g., raw | |
| bundled package 226) | |
| DS3 Loop, DS3 Port, ISDN Loop | 8.7 |
| ISDN Port Bundle (e.g., raw | |
| bundled package 228) | |
| DS3 Loop, DS3 Port, ISDN Loop | 9 |
| ISDN Port Firewall Bundle (e.g., | |
| raw bundled package 230) | |
| DS3 Loop DS3 Port Bundle, ISDN | 8 |
| Loop, ISDN Port (e.g., bundled | |
| package 232) | |
| DS3 Loop DS3 Port Bundle, ISDN | 7.7 |
| Loop ISDN Port Bundle (e.g., | |
| bundled package 234) | |
| DS3 Loop DS3 Port Bundle, ISDN | 8 |
| Loop ISDN Port Firewall Bundle | |
| (e.g., bundled package 236) | |

Additionally, in on embodiment of the present invention, a promotion module 240 can apply promotion patterns 242 (i.e., nontransform patterns) to the raw and bundled packages. For example, Table 9 lists example promotion patterns with associated actions, anchors and rules that can be applied:

TABLE 8

| Promotion | Anchors | Action |
|---|---|---|
| BP24 | DS3 Loop and | Add Free Antivirus |
| | DS3 Port | Software |
| BP35 | ISDN Port ISDN | Additional 25% Discount |
| | Loop Bundle | on Bundle |

Based on these promotions, antivirus software can be added to each of the raw and bundled packages. Additionally, the price of bundled package 228 will change from 8.7 to 8.03 and the price of bundled package 234 will change from 7.7 to 7.03. Rating module 242 can then rate the raw and bundled packages to suggest packages to the user. It should be noted that while the solutions generated by the DN and DIA engines did not include a firewall, several of the recommended packages can include a firewall, as the firewall can be added through the partial matching that occurs during bundling. Additionally, the packages can include antivirus software as the software can be added as a promotion.

In the examples of FIGS. 2-13, the bundle patterns can be associated with a variety of data and processes, such as rules, anchors and pricing/discount information. Therefore, filtering and tracking of information associated with bundles can be done as the raw packages are compared to the bundle patterns. In another embodiment of the present invention, bundle patterns can be compared to raw packages to generate bundled packages and then the bundled packages can be validated and priced. FIG. 16 illustrates another embodiment of system for bundling resources in which validation and pricing occur serially with bundling.

In FIG. 14, a bundling module 252 can apply a set bundle patterns 254 to a set of raw packages 255 to generate a set of bundled packages. A validation module 256 can then determine which of the generated bundled packages are valid by comparing the bundled packages to a list of validity rules. A validity rule can specify, for example, that two services do not go together for business or technical reasons and can reject any bundled package that contains the two services. A pricing module 258 can then calculate prices for the bundled packages, by, for example referencing a look up table of resource and bundle prices. A promotions module 260 can apply promotions (i.e., nontransform patterns) to the valid bundled packages and a rating module 262 can rate the bundled and raw packages to generate a set of recommended packages.

As can be understood from the foregoing, embodiments of the present invention provide a system and method for bundling products and/or services. In one embodiment of the present invention, a set of available resources (e.g., products, options or services) can be compared to a set of bundle patterns to determine if the resources can be bundled. If a set of resources matches a bundle pattern, a bundled package can be formed. Each set of resources can match (fully or partially) one or more bundle patterns to form bundled packages. In one embodiment of the present invention the bundled packages can be rated based on, for example, price and the degree to which the resources satisfy the customer needs to determine the most preferred bundle packages.

The set of resources against which a bundle pattern is compared, in one embodiment of the present invention, can be a raw package that is a member of the cross product of various solutions that meet a user's defined needs. For example, if a user defines that he or she needs a data network and direct internet access, the resources that meet the needs for a data network and the resources that meet the needs for the direct internet access can be different, but may also partially or fully overlap. The raw package can contain the resources to meet each of these needs. The raw package may not be optimal, however, because it contains redundant resources or is not attractively priced. Therefore, the raw package can be further bundled to offer more attractive pricing, eliminate redundancies in products or services or to provide other improvements.

In one embodiment of the present invention, the raw package can be compared to one or more defined bundle patterns to generate packages that contained bundled resources. The bundle patterns can be applied to resources across solutions to bundle resources from one or more solutions in the same raw package. For example, the bundle pattern can be used to bundle resources from both the data network solution and direct internet access solution. This is different than previous bundling systems that typically rely on predefined bundles for each solution.

According to one embodiment of the present invention, partial matching between a raw package and bundle patterns is permitted. With partial matching, a bundled package can be generated that includes resources not in the raw package if the raw package contains at least some of the resources specified by the bundle pattern.

In addition to bundling patterns, transforms can be applied to the raw package or bundled packages and specify that a resource or bundle in the raw package or bundled package should be changed. It should be noted that a bundle pattern is a special case of a transform in which multiple resources are replaced by a single bundle. Additional patterns can also be applied to drive promotions and incentives. Although these patterns may specify the addition of resources to a raw or bundled package, they generally do not change the resources already contained in the raw or bundled package.

Although the present invention has been described in detail, it should be understood that various changes, substitutions and alterations can be made hereto without departing from the scope of the invention as described by the appended claims.

What is claimed is:

1. A system of bundling resources comprising a set of computer instructions stored on a computer readable medium and executable by a computer processor, the set of computer instructions comprising instructions executable to:
receive a set of resources;
compare the set of resources to one or more applicable bundle patterns; and
generate one or more bundled packages based on the comparison.

2. The system of claim 1, wherein the set of computer instructions further comprise instructions executable to:
generate a raw package containing the set of resources based on the cross product of two or more solutions.

3. The system of claim 2, wherein each solution addresses a particular set of user needs.

4. The system of claim 1, wherein the set of computer instructions further comprise instructions executable to:
associate each resource from the set of resources with one or more patterns.

5. The system of claim 4, wherein the one or more patterns comprise at least one bundle pattern.

6. The system of claim 4, wherein the one or more patterns comprise at least one transform.

7. The system of claim 4, wherein the one or more patterns comprise at least one nontransform pattern.

8. The system of claim 3, wherein the set of computer instructions further comprise instructions executable to:
determine a set of potentially applicable bundle patterns associated with the set of resources.

9. The system of claim 8, wherein the set of computer instructions further comprise instructions executable to:
determine the one or more applicable bundle patterns from the set of potentially applicable bundle patterns.

10. The system of claim 8, wherein the set of computer instructions further comprise instructions executable to:
determine the one or more applicable bundle patterns from the set of potentially applicable bundle patterns by filtering the set of potentially applicable bundle patterns based on a set of anchors.

11. The system of claim 8, wherein the set of computer instructions further comprise instructions executable to:
determine the one or more applicable bundle patterns from the set of potentially applicable bundle patterns by filtering the set of potentially applicable bundle patterns based on a set rules.

12. The system of claim 1, wherein the set of computer instructions further comprise instructions that are executable to:
partition the one or more applicable bundle patterns into conflict sets.

13. The system of claim 12, wherein the set of computer instructions further comprise instructions executable to:
perform a comparison between an applicable bundle pattern in a first conflict partition to generate a first set of bindings and a first set of available resources;
perform a comparison between an applicable bundle pattern in a second conflict partition to generate a second set of bindings and a second set of available resources; and
generate a third set of bindings and a third set of available resources based on the union of the first set of bindings and the second set of bindings and the intersection of the first set of available resources and the second set of available resources.

14. The system of claim 12, wherein the set of computer instructions further comprise instructions executable to:
generate a first set of bundled packages based on a first conflict set;
generate a second set of bundled packages based on a second conflict set; and
generate a third set of bundled packages by combining at least one bundled package from the first set of bundled packages and at least one bundled package from the second set of bundle packages.

15. The system of claim 1, wherein each bundle pattern from the one or more applicable bundle patterns further comprises:
one or more components; and
one or more cardinalities.

16. The system of claim 15, wherein the set of computer instructions further comprise computer instructions executable to associate at least one component from at least one of the one or more applicable bundle patterns with a rule.

17. The system of claim 15, wherein the set of computer instructions further comprise computer instructions executable to associate at least one component from at least one of the one or more applicable bundle patterns with pricing data.

18. The system of claim 15, wherein the set of computer instructions further comprise computer instructions executable to associated at least one bundle pattern from the one or more applicable bundle patterns with a rule.

19. The system of claim 15, wherein the set of computer instructions further comprise computer instructions executable to associated at least one bundle pattern from the one or more applicable bundle patterns with pricing and discount data.

20. The system of claim 15, wherein the set of computer instructions further comprise computer instructions executable to associated at least one bundle pattern from the one or more applicable bundle patterns with an anchor.

21. The system of claim 1, wherein the set of computer instructions further comprise instructions executable to apply a nontransform pattern to at least one of the one or more of the bundled packages.

22. The system of claim 21, wherein the nontransform pattern is a promotion pattern.

23. The system of claim 1, wherein the set of computer instructions further comprise instructions executable to apply a nontransform pattern to one or more of the set of resources.

24. The system of claim 22, wherein the nontransform pattern is a promotion pattern.

25. The system of claim 1, wherein the set of computer instructions further comprise instructions executable to rate the one or more bundled packages.

26. The system of claim 1, wherein the set of computer instructions further comprise instructions executable to apply a transform to the set of resources to replace at least one resource from the set of resources with another resource.

27. The system of claim 1, wherein set of computer instructions further comprise instructions executable to apply a transform to the one or more bundled packages.

28. The system of claim 1, wherein comparing the set of resources to one or more applicable bundle patterns further comprises fully matching the one or more applicable bundle patterns.

29. The system of claim 1, wherein comparing the set of resources to one or more applicable bundle patterns further comprises partially matching the one or more applicable bundle patterns.

30. A method of bundling resources comprising:
receiving a set of resources;
compare the set of resources to one or more applicable bundle patterns; and
generate one or more bundled packages based on the comparison.

31. The method of claim 30, further comprising:
generating a raw package containing the set of resources based on the cross product of two or more solutions.

32. The method of claim 31, wherein each solution addresses a particular user need.

33. The method claim 1, further comprising:
associate each resource from the set of resources with one or more patterns.

34. The method of claim 33, wherein the one or more patterns comprise at least one bundle pattern.

35. The method of claim 33, wherein the one or more patterns comprise at least one transform.

36. The method of claim 33, wherein the one or more patterns comprise at least one nontransform pattern.

37. The method of claim 32, further comprising:
determining a set of potentially applicable bundle patterns associated with the set of resources.

38. The method of claim 37, further comprising:
determining the one or more applicable bundle patterns from the set of potentially applicable bundle patterns.

39. The method of claim 37, further comprising:
determining the one or more applicable bundle patterns from the set of potentially applicable bundle patterns by filtering the set of potentially applicable bundle patterns based on a set of anchors.

40. The method of claim 37, further comprising:
determining the one or more applicable bundle patterns from the set of potentially applicable bundle patterns by filtering the set of potentially applicable bundle patterns based on a set rules.

41. The method of claim 30, further comprising:
partitioning the one or more applicable bundle patterns into conflict sets.

42. The method of claim 41, further comprising:
performing a comparison between an applicable bundle pattern in a first conflict partition to generate a first set of bindings and a first set of available resources;
performing a comparison between an applicable bundle pattern in a second conflict partition to generate a second set of bindings and a second set of available resources; and
generating a third set of bindings and a third set of available resources based on the union of the first set of bindings and the second set of bindings and the intersection of the first set of available resources and the second set of available resources.

43. The method of claim 41, further comprising:
generating a first set of bundled packages based on a first conflict set;
generating a second set of bundled packages based on a second conflict set; and
generating a third set of bundled packages by combining at least one bundled package from the first set of bundled packages and at least one bundled package from the second set of bundle packages.

44. The method of claim 30, wherein each bundle pattern from the one or more applicable bundle patterns further comprises:
one or more components; and
one or more cardinalities.

45. The method of claim 44, further comprising:
associating at least one component from at least one of the one or more applicable bundle patterns with a rule.

46. The method of claim 44, further comprising:
associating at least one component from at least one of the one or more applicable bundle patterns with pricing data.

47. The method of claim 44, further comprising:
associating at least one bundle pattern from the one or more applicable bundle patterns with a rule.

48. The method of claim 44, further comprising:
associating at least one bundle pattern from the one or more applicable bundle patterns with pricing and discount data.

49. The method of claim 44, further comprising:
associating at least one bundle pattern from the one or more applicable bundle patterns with an anchor.

50. The method of claim 30, further comprising:
applying a nontransform pattern to at least one of the one or more bundle packages.

51 The method of claim 50, wherein the nontransform pattern is a promotion pattern.

52. The method of claim 30, further comprising:
applying a nontransform pattern to one or more of the set of resources.

53. The method of claim 52, wherein the nontransform pattern is a promotion pattern.

54. The method of claim 30, further comprising:
rating the one or more bundled packages.

55. The method of claim 30, further comprising:
applying a transform to the set of resources to replace at least one resource from the set of resources with another resource.

56. The method of claim 30, further comprising:
applying a transform to the one or more bundled packages.

57. The method of claim 30, wherein comparing the set of resources to one or more applicable bundle patterns further comprises fully matching the one or more applicable bundle patterns.

58. The method of claim 30, wherein comparing the set of resources to one or more applicable bundle patterns further comprises partially matching the one or more applicable bundle patterns.

59. A system of bundling products comprising a set of computer instructions stored on a computer readable medium and executable by a computer processor, the set of computer instructions comprising instructions executable to:
maintain a set of patterns;
maintain a set of resources;
associate each resource from the set of resources with one or more patterns from the set of patterns;
generate a raw package containing at least one resource from the set of resources;
determine a set of potentially applicable patterns based on associations between each of the at least one resources in the raw package and the set of patterns;
filter the set of potentially applicable patterns based on rules and anchors associated with each potentially applicable pattern to determine a set of applicable patterns, wherein the set of applicable patterns further comprises a set of applicable bundle patterns; and
compare the set of applicable bundle patterns to the raw package to generate a set of bundled packages.

60. The system of claim 59, wherein the set of computer instructions further comprise instructions executable to generate a raw package based on a cross product of two or more solutions.

61. The system of claim 60, wherein each solution from the two or more solutions addresses a particular customer need.

62. The system of claim 59, wherein the computer instructions further comprise instructions executable to:
partition the set of applicable patterns into the set of applicable bundle patterns and a set of applicable nontransform patterns.

63. The system of claim 62, wherein the computer instructions further comprise instructions executable to: partition the set of applicable bundle patterns into a set of conflict partitions.

64. The system of claim 63, wherein the set of computer instructions are further executable to:
perform a comparison between an applicable bundle pattern in a first conflict partition to generate a first set of bindings and a first set available resources;
perform a comparison between an applicable bundle pattern in a second conflict partition to generate a second set of bindings and a second set of available resources; and
generate a third set of bindings and a third set of available resources based on the union of the first set of bindings and the second set of bindings and the intersection of the first set of available resources and the second set of available resources.

65. The system of claim 63, wherein the set of computer instructions further comprise instructions executable to:
generate a first set of bundled packages based on a first conflict set;
generate a second set of bundled packages based on a second conflict set; and
generate a third set of bundled packages by combining at least one bundled package from the first set of bundled packages and at least one bundled package from the second set of bundle packages.

66. The system of claim 62, wherein the set of computer instructions further comprise instructions executable to apply the set of nontransform patterns to the set of bundled packages and the raw package.

67. The system of claim 59, wherein the set of computer instructions further comprise instructions executable to replace at least one resource in the raw package with another resource based on a transform.
